(19) United States
(12) Patent Application Publication
(10) Pub. No.: US 2023/0129508 A1
(43) Pub. Date: Apr. 27, 2023

(54) METHODS FOR SPREADING SEED AS SINGLE GRAINS TOGETHER WITH A SEED CAPSULE, AND SEED CAPSULE

(71) Applicant: Marian Ivanov Dichevski, Varna (BG)

(72) Inventor: Marian Ivanov Dichevski, Varna (BG)

(21) Appl. No.: 17/787,464

(22) PCT Filed: Dec. 23, 2019
(86) PCT No.: PCT/EP2019/086935

§ 371 Date: Dec. 8, 2022

(51) Int. Cl. A01C 7/06; C05G 5/30; A01C 7/04

(52) U.S. Cl. CPC A01C 7/06; C05G 5/30; A01C 7/04

(57) ABSTRACT

A method for single-grain application of seed by means of an agricultural sowing unit with at least one sowing element (200), which has a metering device (210) and a single grain-laying device (220), for the single-grain depositing of the seed along or within a seed furrow (310) arranged in the soil (300). A single grain (320) of seed is deposited along or within the seed furrow (310), adjacent to individual grains (320) of seed at a distance (l₁) that can be selected or adjusted as required. A selectable or predetermined number (x) of seed capsules (100) is assigned to each single grain (320) of seed, whereby the seed capsules (100) are placed adjacent to the assigned single grain (320) along or within the seed furrow (310), and the active or stimulating substances (140) contained in the seed capsules (100) are released to support the associated single grain (320).

### BACKGROUND OF THE INVENTION

The invention relates to a method for the single-grain seeding by means of an agricultural sowing unit with at least one sowing element, which sowing element has a metering device and a single-grain laying device for the single-grain depositing of the seed along and/or within a seed furrow arranged in the ground, where one single grain of the seed is deposited along and/or within the seed furrow in a selectable and/or adjustable distance to the respectively adjacent individual grains of the seed.

The so-called single-grain sowing or single-grain depositing is mainly used for industrially grown crops such as maize, sunflowers, hemp, cotton, soy and other single-grain crops, the yield of which depends on an even plant spacing on the field and which are applied by a precision seeder. Usually the seeds are first separated (e.g. by means of mechanical or pneumatic grain separation) and each single grain is deposited “grain by grain” with the help of control systems at a predetermined distance to the respective neighboring single grains along or within the seed furrow drawn into the ground. The distance to be determined depends on the respective climatic conditions, the prevailing soil conditions, etc. and of course on the crop itself and is specified by a crop cultivation specialist. The distance to be determined in each case is usually extremely different in different countries.

For a successful sowing and a high yield, on the one hand, a high seed-to-soil-contact is decisive, which is why the seed furrow is closed again after the individual grains have been deposited, so that the individual grains are arranged in the required soil depth. The required soil depth depends on the respective climatic conditions, the prevailing soil conditions, etc. and of course on the crop itself and is specified by a crop cultivation specialist. The three most important aspects for determining the required soil depth are firstly the moisture content of the soil, secondly the germination energy of the seeds and thirdly the precipitation forecasts for the coming days. Usually the top soil layer is too dry for successful sowing due to solar radiation and drying out, so the seeds and/or single grains must be placed deeper, at a depth with sufficient moisture content. In different countries, the required depth of the ground is usually very different.

For example, you can find a sowing unit from the company Kuhn S. A. that can be attached to an agricultural tractor for depositing single grains, under the following link: https://www.kuhn.de/internet/webde.nsf/0/C125790C0036B31EC12 57CAC002CB85A (accessed on Nov. 18, 2019). The sowing unit shown here comprises two sowing elements which are arranged offset to one another with respect to the pulling direction and which are provided for the single-grain placement of two adjacent seed furrows. For this purpose, each sowing element has a hose-like individual grain-laying device, which is supplied with the separated seeds by a metering device not shown in the figures that can be called up.

A similar sowing unit, for example, is disclosed in patent specification EP 2 747 541 B1. The seed dispensing device (sowing unit) described herein comprises a seed meter which transports a single seed via a seed disk to a seed conveyor belt. The seed conveyor belt is divided into chambers by means of a large number of screw blades, each of which is provided for receiving a single grain. A single grain is released from the seed disk to an upper end of the seed conveyor belt and transported to its lower end by means of the conveyor belt. The lower end opens into a prepared seed furrow and the seed is deposited within. By varying the pulling speed with which the seed dispensing device is pulled along the seed furrow and varying the running speed of the seed conveyor belt, the distance between the individually deposited seeds is predetermined.

Patent specification EP 2 996 454 B1 discloses a sowing unit in which fertilizers can also be applied together with the seed, which fertilizers supply the seed with chemical nutrients such as nitrogen or phosphorus. The showed sowing unit has a metering system with which different agricultural products, e.g. seeds, fertilizer compositions, insecticides, herbicide compositions and inoculants are stored in separate bulk storage chambers and based, in particular on recognized soil factor variables, are combined into a selectively metered and mixed combination via selectively controllable metering devices. The prepared combination of agricultural products is fed to the ground or deposited in prepared seed furrows via a multi-port opener comprising three seed deposit openings.

Another possibility of supplying the deposited seeds with nutrients directly during sowing is known from U.S. Pat. No. 9,918,426 B2. The device described there is designed to inject liquid fertilizer into the seed furrow via a “sprinkler” for each individual grain—a photo sensor detects the placement of the seed and at the same time, a signal for injecting the liquid fertilizer via a controller is given. The fertilizers or pesticides brought in together with the seed are effective immediately. After about one to two weeks, however, the effectiveness decreases, either because the nutrients contained are used up or e.g. diluted by precipitation and/or removed from the seed or seedling.

In addition to the precise placement of individual grains, an as simultaneously as possible seeds germination, preferably within a period of 24 to 48 hours, is also essential for a high harvest yield.

For example, it is usual to plant the seeds for cultivation of maize at the end of March to April, since during these months the soil temperature is already around 8° C. The seeding process can be started at this soil temperature without fear of damage to the seed from the cold. In order to be able to start sowing earlier in the year (for example at soil temperatures around 5° C.), a so-called “polymer coating” of the seeds is known from the companies Pioneer Hi Bred International, Inc. and Monsanto Company, which surrounds individual seeds with a polymer coating and thus protects them from too cold soil temperatures. From a temperature of approx. 8° C., the polymer coating dissolves in order to start germination of the seeds that have been applied as simultaneously as possible. Such “delayed germinating” seeds cannot be supplied with the previously described devices through an initial fertilization.

Similar coatings are also known for chemical fertilizers. Thus, WO 2012/074557 A1 discloses a mandrel, which is “pierced” with granulated or pelletized and coated fertilizer in the immediate vicinity of the already sprouted crop in order to subsequently refresh the fertilization. The disadvantage of this method is the additional work step required next to the sowing, in which the fertilizer spike is laboriously pushed into the ground by hand (as is also known from commercially available fertilizer sticks) next to the plant (tomatoes or rose bushes are mentioned here as examples). An implementation of the described fertilizer application on an industrial, large-scale agricultural scale is unthinkable.

In any case, industrial, agricultural field cultivation is also developing away from the high use of chemical fertilizers and towards more environmentally friendly, biological solutions. The disadvantage of chemical fertilizers, which mainly contain nutrients for plants such as nitrogen, potassium, phosphorus, magnesium, sulfur, calcium, etc., is the high salt content, which is harmful to the germination of the seed.

As a modern practice in agriculture, adding different (living or effective) microorganisms and/or other biostimulators to different types of crops is becoming more and more popular. Similar to the liquid fertilizer injection described above, the microorganisms and/or biostimulators have so far also been applied by means of a spray device, with the majority of the applied microorganisms and/or biostimulators remaining on the soil surface and not penetrating the soil. In order to protect the mostly not UV-resistant microorganisms and/or biostimulators from solar radiation, further interventions are carried out to work them into the soil. This is associated with higher costs and often with the destruction of the expensive microorganisms and/or biostimulators. In addition, the life cycle of the microorganisms and/or biostimulators is of different length, which is why the effectiveness of the application decreases after a certain period. This requires a recultivation of the same field area and then possibly third or more work steps, which complicates the soil cultivation and increases the processing costs. Depending on the crop, it is not always possible to carry out such post-processing.

It is therefore an object of the present invention to eliminate the disadvantages of the prior art and to create an improved method for the single-grain seeding. In particular, a more environmentally friendly and more productive cultivation of the field should be made possible without significantly increasing the costs, especially during the seed application and/or through subsequent work steps.

The object is achieved by a method for the single-grain application of seeding according to claim 1 and by a seed capsule according to claim 11. Advantageous embodiments of the invention are claimed in the corresponding subclaims.

### SUMMARY OF THE INVENTION

A method according to the invention of the type described more detailed at the beginning is characterized in that to each individual grain of the seed is assigned an optionally selectable and/or predetermined number of seed capsules, also referred to as “intelligent” capsules (in English “smart capsules”), which are placed adjacent to the assigned single grain along and/or within the seed furrow, and active and/or stimulation substances contained in the seed capsules are released to support and/or stimulate the assigned single grain. The single grain itself is not contained in the seed capsule. By using seed capsules or smart capsules, the release, in particular a time-delayed release, of the active and/or stimulation substances can be “intelligently” adapted to the particular needs of the individual grain.

According to the method of the invention, provision is made for seed capsules comprising active and/or stimulating substances to be added together with the single grains placed within the seed furrow, directly or in the immediate vicinity of the seed. So that these active and/or stimulating substances are added, preferably after the single grain has been deposited and the seed capsules have been placed, in particular to be released with a delay relative to the grain.

The active and/or stimulatory substances contained in the seed capsule have the task, through their release, in particular a time-delayed release, to biologically support the single grain during germination or subsequent growth, in particular to stimulate the plant's own signal substances (phytoalexins) and thus the plant's own defense to strengthen against pests, diseases or fungal attack, etc.

For the purposes of the present invention, a distinction is therefore made between so-called active and/or stimulatory substances and conventional, chemical and/or mineral fertilizers. According to the invention, active and/or stimulatory substances are understood to mean so-called biostimulators. Biostimulators are well known in the agricultural sector and are commercially available. Most of them are organic substances of animal or vegetable origin, such as so-called effective microorganisms (aerobic or anaerobic microorganisms), amino acids, humic acids, fulvic acids, algae or seaweed extracts, beneficial fungi, e.g. mycorrhizal fungi and bacteria, chitin and chitosan but also partly inorganic components. The following biostimulators, among others, are commercially available: metabolism-based fermantators (fermentation metabolite-based “FM”), Ecklonia maxima seaweed extracts (SE1), plant growth regulators (PGR), synthetic formulas containing antioxidant (“SF”), protein hydrolysates (“PH1”, “PH2”), Ascophyllum nodosum seaweed extracts (“SE2”, “SE3”). Chemical and/or mineral fertilizers, on the other hand, are understood to mean “dead” nutrient mixtures for plants that contain, for example, nitrogen, potassium, phosphorus, magnesium, sulfur, calcium, etc. and are “sprayed” in particular in liquid or atomized form.

In summary, active and/or stimulatory substances serve the purpose of supporting the single grain and/or the plant by strengthening the plant's own defenses, whereas chemical and/or mineral fertilizers “feed” the single grain and/or the plant with nutrients required for growth.

In an optional embodiment of the invention, it is also conceivable that the seed capsule also contains nutrients and/or mineral/chemical fertilizers in addition or as an alternative to the active and/or stimulating substances. In particular, active and/or stimulation substances can be contained in one intake volume and nutrients and/or mineral/chemical fertilizers in another intake volume or an encasing layer.

Advantageously, with the method according to the invention, in particular the devices known from the prior art for depositing single grains can be used unmodified or with only minor modifications in order to place a predetermined and desired number x of seed capsules within the seed furrow in addition to each deposited single grain.

For this, it is essential that the capsule has a shape that is suitable for spreading with such sowing units or single-grain laying devices. In particular, the volume and/or weight and/or external shape of the seed capsule can correspond to the shape of the associated individual grain. Rounded shapes, such as a sphere or a rotational ellipsoid, roughly the size of the respectively assigned individual grain are particularly suitable.

The number x of the seed capsules to be assigned to a single grain can be specified based on various factors. Relevant is for example the (variety-dependent) need for active and/or stimulation substances of the respective single grain in correlation with the size of the seed capsules or their possible filling quantity with active and/or stimulation substances. Furthermore, it is also conceivable to assign two, three or more seed capsules each with different active and/or stimulatory substances, in particular microorganisms and/or biostimulators, to a single grain; alternatively, different active and/or stimulatory substances, in particular microorganisms and/or biostimulators, can be contained in one and the same seed capsules. If necessary, a number x=0.5 can be specified, with a seed capsule being assigned to two individual grains. If a number x=1 is specified, exactly one seed capsule is assigned to each individual grain, if a number x=2 or x=3 is specified, exactly two or exactly three seed capsules etc. corresponding to each individual grain, etc. The number of assigned seed capsules is preferably in a range between x=0.1 and x=10, whereby the number of seed capsules that are assigned to each individual grain is fixed for each sowing and is precisely adhered to during sowing.

Due to this indirect support of a single grain with active and/or stimulating substances by means of seed capsules, the active and/or stimulating substances contained, in particular, effective microorganisms and/or bio-stimulators, can be applied together with the seed or the single grain, but released with a time delay. So they can be protect from weather conditions, UV exposure and/or mechanical stress during application/sowing. In this way, the active and/or stimulation substances protected in the seed capsules can be placed in one work step with the same means or with the same device and at the same time as the seed. In particular, the release of the active and/or stimulatory substances can be “intelligently” adapted to the prevailing needs of the single grain and/or the plant at the respective point in time, in that the active and/or stimulatory substances are released with a time delay to the respective point in time. The seed capsule according to the invention is therefore also referred to as a “smart capsule”.

A distinction must be made here in particular between “slow release” in which ingredients are released “gradually” over a longer period, e.g. also known from the pharmaceutical industry in connection with tablets and drugs and the “postphoned release” according to the invention in which the ingredients are released for the first time and preferably “all at once” after the desired period of time.

With the method according to the invention, the sowing and germination process of the most varied of crop plants can advantageously be optimized and carried out with maximum efficiency. From an environmental technology point of view, this also has a reducing effect on carbon emissions, as the soil cultivation steps are reduced and the use of chemical fertilizers, fungicides and insecticides is reduced or even eliminated.

In an optional embodiment of the method, it is advantageous that the seed capsule or each seed capsule has at least one receiving volume and at least one soluble and/or decomposable layer encasing the receiving volume, whereby the encasing layer for release in particular for the time-delayed release of the active substances contained and/or stimulation substances, is dissolvable and/or decomposable.

In order to be able to efficiently protect the contained active and/or stimulation substances by the seed capsule, the latter is designed with a receiving volume which is advantageously located in the interior of the seed capsules and is designed for receiving the active and/or stimulating substances, or respectively for different active and/or active substances or a single stimulation substance is filled. It is conceivable that the active and/or stimulation substances are present in the receiving volume of the seed capsule in a liquid or viscous form; however, but the active and/or stimulation substances or the one stimulation substance preferably have a solid state of aggregation. The receiving volume is limited or surrounded by a covering layer. The encased layer is designed to be dissoluble and/or decomposable, so that the active and/or stimulation substances contained in the receiving volume are released in that the encased layer is dissolvable and/or decomposable.

In a further development of this method option, the at least one encasing layer of the seed capsule is water-soluble and is dissolved by contact with the surrounding soil in order to release the active and/or stimulating substances contained in the at least one receiving volume.

A comparatively simple implementation of a soluble and/or decomposable coating layer can be achieved by making the coating layer water-soluble, in particular from a water-soluble material such as starch, gelatin, etc. In this execution, the disintegration and/or decomposition of the coating takes place through contact with the surrounding soil, more precisely with the moisture content of the soil. Similar to the germination of the single grain, in which the highest possible seed-to-soil contact has a positive effect, it is also advantageous for the dissolution and/or decomposition of the coated layer of the seed capsule if it has an as good as possible high capsule-to-soil-contact. Optionally or alternatively, the dissolution and/or decomposition can also take place as a function of temperature factors, in particular the ambient and/or soil temperature and/or as a function of time.

It is also appropriate, according to an advantageous embodiment of the method, that an optionally selectable time interval for determining a release period and/or time is specified between the placement of the seed capsules along and/or within the seed furrow and the release of the active and/or stimulating substances contained in the seed capsules.

It can be particularly advantageous to release the active and/or stimulating substances contained in the seed capsule at certain germination or growth stages of the single grain or of the seedling or of the cultivated plant. If, for example, active and/or stimulatory substances in the form of mycorrhizal fungi are contained in the seed capsules, they should only be released for the germination of the single grain, after about two weeks, when the first fine roots have appeared, i.e. are formed. This release period and/or release time can be predetermined or set in particular by the disintegration time of the seed capsule, more precisely of the encasing layer.

A single grain usually germinates after approx. 10-14 days, which is why an appropriate first time interval for establishing a first release period and/or release time should be in a range between approx. 9-13 days, for the initial support of the germinating single grain, in particular with bacteria and/or molasses. An appropriate second time interval could be chosen in a range of approx. 14-21 days in order to supply the roots of the already germinated single grain, in particular with mycorrhizal fungi, and thus to support further growth. After a third time interval has elapsed, it is conceivable to supply the initially released bacteria with nutrients, in particular molasses, and to increase their activity.

In the method configuration described above, it is particularly useful if the time interval between the placement of the seed capsules and the release of the active and/or stimulating substances, i.e. the disintegration time of the seed capsule, is specified via the solubility and/or the layer thickness of the encasing layer.

The optionally selectable time interval is preferably specified on the basis of the dissolution and/or decomposition conditions for the seed capsule. This means that the time interval is set on the basis of the time elapsed from the placement, in particular on the basis of the layer thickness and/or on the basis of the moisture, in particular soil moisture and/or on the basis of the temperature, in particular soil temperature.

It is of course also conceivable that different disintegration times are set for different seed capsules which contain different and/or identical active and/or stimulating substances or a different time interval is specified between the placement of the seed capsules and the release of the active and/or stimulating substances.

If, in the specific example, a certain microorganism can provide optimal support for the single grain or the seedling over a period of 14 to 21 days, a number of three seed capsules could be assigned to a single grain and placed together with it. The seed capsules each contain the same stimulation substance, but are designed with different disintegration times. In this way, three time intervals can be specified with an interval of approx. 15 days each (e.g. 30 days, 45 days and 60 days) within which the seed capsules are successively dissolved and/or decomposed. Depending on the crop, a high percentage of its vegetative cycle can be supplied in this way with useful microorganisms and/or biostimulators, the viable activity of which takes place in parallel with the growth or vegetation of the crop. In other words, the active and/or stimulating substances, in particular microorganisms and/or biostimulators are always released when there is a high demand due to germination and/or a growth phase, etc.

The optimal support of the single grain and/or the seedling or the cultivated plant with partly symbiotic microorganisms and/or biostimulators can increase their natural resistance to pests such as insects or fungal attack, which in turn saves a considerable amount of insecticides or fungicides.

Optionally, according to an optional embodiment of the method, a seed capsule can also have at least two receiving volumes and at least two soluble and/or decomposable, in particular water-soluble, layers encasing a respective receiving volume. The coated layers for release, in particular for the delayed release, of the contained active and/or stimulation substances are dissolved and/or decomposed at release periods and/or release times that differ from each other, in particular through contact with the surrounding soil.

That is to say, different intake volumes can contain different active and/or stimulatory substances, which are activated at intervals, i.e. successive dissolution and/or decomposition of the respective encasing layers are released at different release periods and/or release times. In the case of a water-soluble, encasing layer that dissolves and/or decomposes through contact with the ground, it can be used, for example, that initially only the outermost encasing layer is in contact with the ground. Only after the outermost encasing layer has dissolved and the active and/or stimulation substances surrounding it have been released does an underlying encasing layer are exposed to the surrounding soil. So the active and/or stimulation substances contained within this underlying encasing layer can be released at a subsequent release period and/or release time, i.e. after a longer time interval.

For the placement of the seed capsules, in particular also with regard to the sowing unit used for this purpose, it is provided according to a variant of the method that the seed capsules are placed by means of the sowing element along and/or within the seed furrow essentially at the same time as the assigned individual grain. Thus, the seed capsules and the assigned individual grains are arranged in the immediate vicinity of one another, and in particular in contact with one another.

Alternatively, however, according to another variant of the method, it is also conceivable that the seed capsules are placed or deposited with a time offset in relation to the assigned single grain by means of the sowing element along and/or within the seed furrow, whereby the seed capsules and the assigned single grain in the immediate vicinity and are arranged at a distance from one another, and which distance is specified on the basis of the time offset.

For example, by modifying known sowing units, it can be provided for a method configuration that the sowing element has at least one first metering device for placing the seed capsules and at least one second metering device for depositing the assigned single grain. The seed capsules and the assigned single grain are placed or deposited within the seed furrow along and/or via a common single grain laying device.

With this modification, it is advisable to feed the seed capsules and the assigned single grains synchronously, but with a slight time lag, to the common single grain placement in order to prevent them from blocking each other within the channel and/or the line of the single grain placement device.

Alternatively, in a variation of the method according to the invention, the sowing element can have a common metering device for placing the seed capsules and for depositing the assigned single grain, by means of which both the seed capsules and the seeds are separated, and the seed capsules and the assigned single grain are deposited and/or placed inside the seed furrow.

The object of the invention set out at the beginning is also achieved by a seed capsule, suitable for placing individual grains by means of an agricultural sowing unit with at least one sowing element, in particular according to a method described above.

According to the invention, such a seed capsule is characterized in that the seed capsule has at least one receiving volume containing one or more different active and/or stimulating substances and at least one soluble and/or decomposable layer encasing the receiving volume. The encasing layer can be dissolved and/or decomposed to release, in particular for a time-delayed release, the contained active and/or stimulating substances.

In order that the seed capsule can be applied with conventional sowing units using the single-grain method, it is essential that the seed capsule has a shape which is suitable for application with such sowing units or single-grain laying device. In particular, the volume and/or weight and/or external shape of the seed capsule can correspond to the shape of the associated individual grain. Rounded shapes, such as a sphere or an ellipsoid of revolution, roughly the size of the respectively assigned individual grain are particularly suitable.

Preferably, the seed capsule can also be small, in particular smaller than a single grain, with a single encasing layer and a single receiving volume, whereby the one receiving volume also including different active and/or stimulating substances e.g. may contain in dry and/or solid form as powder and/or granules. Such small seed capsules are particularly useful for the application of small seeds, e.g. rye or wheat suitable.

Another, alternative embodiment of the seed capsule provides that it is “pressed” in the form of a pellet. In this form, from each other less sensitive (non-living) biostimulators such as fulvic acids and/or algae or seaweed extracts are used. In this form, it is also possible to make the seed capsule with a very small size and so to be added to the seeds in the desired ratio even with a non-single grain sowing of e.g. rye or wheat.

In an optional embodiment, the seed capsule can also have liquid-absorbing and/or liquid-storing substances, such as water-absorbing polymers, talc or talcum, bentonites, starch, etc. In this way, moisture can be kept in the seed capsule, because of which the environmental parameters present in the interior of the seed capsule can be optimized for the active and/or stimulating substances contained, in particular microorganisms.

In order to use, in particular, different active and/or stimulating substances in succession at intervals, e.g. to release them at different release times and/or release periods, an advantageous embodiment of the seed capsule consists of at least two, each containing one or more different active and/or stimulating substances and at least two soluble and/or decomposable and a respective absorption volume encasing layers. The encasing layers and the respective receiving volume for the release, in particular for the time-delayed release, of the active and/or stimulating substances contained at different release periods and/or release times, are arranged outwards encasing each other from the center of the seed capsule.

Starting approximately from the center of the preferably spherical or ellipsoidally shaped seed capsule, several receiving volumes and encasing layers can extend radially outwards. A first or innermost receiving volume is expediently located in the area of the center point of the seed capsule, which is surrounded by a first encasing layer. A second receiving volume can be arranged surrounding the first encasing layer, which in turn is surrounded by a second, in particular an outermost encasing layer. In principle, it is conceivable to provide any number of further receiving volumes and encasing layers in between, whereby a number of receiving volumes and encasing layers in a range between one and three having proven to be appropriate.

In an advantageous embodiment, the active and/or stimulation substances contained in the at least one intake volume are biostimulators, in particular effective microorganisms and/or amino acids and/or humic acids and/or fulvic acids and/or algae or seaweed extracts and/or beneficial fungi and/or mycorrhizal fungi and/or beneficial bacteria and/or chitin and/or inorganic components and/or molasses.

For example, the bacteria can be used to adjust the pH of the soil, the mycorrhizal fungi enter into a symbiosis with the roots of the seedling, humus and/or molasses can serve as a breeding ground for the bacteria and/or microorganisms and/or fungi.

Finally, according to a seed capsule variant, it is also advantageous that the at least one encasing layer is soluble and/or decomposable, in particular water-soluble, and consists of a carbon-containing material and/or a gel structure and/or a starch-containing material and/or biodegradable plastics, in particular polymers and/or a material containing gelatin.

### BRIEF DESCRIPTION OF THE SEVERAL VIEWS OF THE DRAWINGS

Further details, features, (sub) combinations of features, advantages and effects based on the invention emerge from the following description of preferred exemplary embodiments of the invention and the drawings.

These, show in

FIG. 1 a schematic flow diagram of an exemplary variant of the method according to the invention,

FIG. 2 a schematic sectional illustration of a first exemplary embodiment of the seed capsule according to the invention with an encasing layer and a receiving volume,

FIG. 3 a schematic sectional illustration of a second exemplary embodiment of the seed capsule according to the invention with two encasing layers and two receiving volumes,

FIG. 4 a schematic perspective illustration of a first exemplary modification of a sowing element known from the prior art for carrying out the method according to the invention,

FIG. 5 a schematic plan view of a second exemplary modification of a sowing element known from the prior art for carrying out the method according to the invention,

FIG. 6 a schematic perspective illustration of a third exemplary modification of a sowing element known from the prior art for carrying out the method according to the invention and

FIG. 7 a schematic perspective illustration of a fourth exemplary modification of a sowing element known from the prior art for carrying out the method according to the invention.

In the images, the same elements are always provided with the same reference numerals, which is why they are usually only described once.

### DETAILED DESCRIPTION OF THE INVENTION

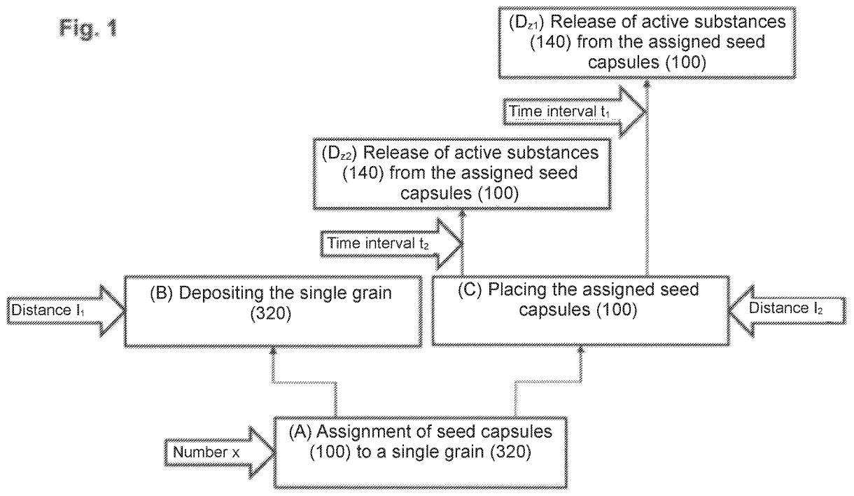

According to FIG. 1, an exemplary embodiment variant of the method according to the invention for the single grain application of seed is illustrated with the aid of a schematic flow diagram, whereby the following method steps are being included:

(A) Assigning seed capsules 100 to a single grain 320,

(B) Depositing the single grain 320 within and/or along a prepared seed furrow 310,

(C) Placing the seed capsules 100 assigned to the single grain 320 within and/or along the prepared seed furrow 310,

(D) Release of active and/or stimulation substances 140 from the assigned seed capsules 100.

Parameters to be specified and/or adjustable for the respective process steps are shown in FIG. 1 by means of arrows and include:

x: the number of seed capsules 100 assigned to each individual grain 320,

l₁: the first distance by which adjacent individual grains 320 are deposited within and/or along the seed furrow 310 at a distance from one another,

l₂: the second distance by which the seed capsules 100 are placed at a distance from the assigned single grain 320,

t₁: the first time interval between the placement of the seed capsules 100 and the first release time and/or release period z₁ of active and/or stimulation substances 140,

t₂: the second time interval between the placement of the seed capsules 100 and the first release time and/or release period z₂ of active and/or stimulatory substances 140.

As described at the beginning, the prior art discloses a number of devices for depositing seed by single grain (step B) within and/or along a seed furrow 310. In this case, the seed is first separated and the individual grains 320 are then deposited at a predeterminable distance l₁ from one another within and/or along a seed furrow 310. The distance l₁ to be maintained between the individual grains 320 is based on the so-called seed application standard, which is specified by a farmer or agronomist and is firmly set on the sowing device or the sowing unit before the seeds are spread. Usually, the standard specifies the number of individual grains to be applied per field area and, depending on the number of sowing devices or sowing units running parallel to one another in several rows, the distance to be set can be calculated. With mechanical sowing units, the pulling speed at which the sowing unit is pulled must also be taken into account. Alternatively, during the spreading of the individual grains 320, the distance l₁ can be automatically readjusted as a function of the pulling speed at which the sowing unit is pulled and/or via the rotation or running speeds of metering devices 210.

According to the exemplary variant of the invention shown in FIG. 1, in step (A) to each individual grain 320, preferably before it is deposited in the seed furrow 310, is assigned a predetermined number x of seed capsules 100. The number x can be predetermined, for example, via the use of further metering devices 210 and/or their equipping with single grains 320 or seed capsules 100 and can be freely selected if necessary.

The number x to be set can take into account different factors, including whether or how many different active and/or stimulation substances 140 are to be used and whether these are to be released at different release periods and/or release times z₁, z₂. For example, it is useful to assign a seed capsule 100 to each individual grain 320 per stimulation substance 140 and per release period and/or release time z₁, z₂, so the number x of seed capsules 100 assigned to each individual grain 320 then corresponds to the total number of release periods and/or release times z₁, z₂ and active and/or stimulation substances 140.

Steps (B), depositing the single grain 320 and (C), placing the seed capsule 100, can be carried out simultaneously or with a time offset from one another. By, for example, placing the seed capsules 100 by a predetermined time offset after the single grain 320 has been deposited; a correspondingly correlating distance l₂ between the single grain 320 and the assigned seed capsules 100 can be set.

According to step (D), active and/or stimulating substances 140 contained in the seed capsules 100 can be released at different release periods and/or release times z₁, z₂ by setting corresponding time intervals t₁, t₂ between the placement of the seed capsules 100 and the release of the active and/or stimulation substances 140. The time intervals t₁, t₂ are preferably set via different disintegration times of assigned the seed capsules 100, in particular by defining the layer thickness of an encasing layer 120 and/or its solubility. Alternatively, an interval release according to time intervals t₁, t₂ deviating from one another can also be set by a single seed capsule 100 with several encasing layers 120, where the encasing layers 120 are dissolved and/or decomposed successively for the release of active and/or stimulating substances 140 contained in between, starting with the outermost one layer 120.

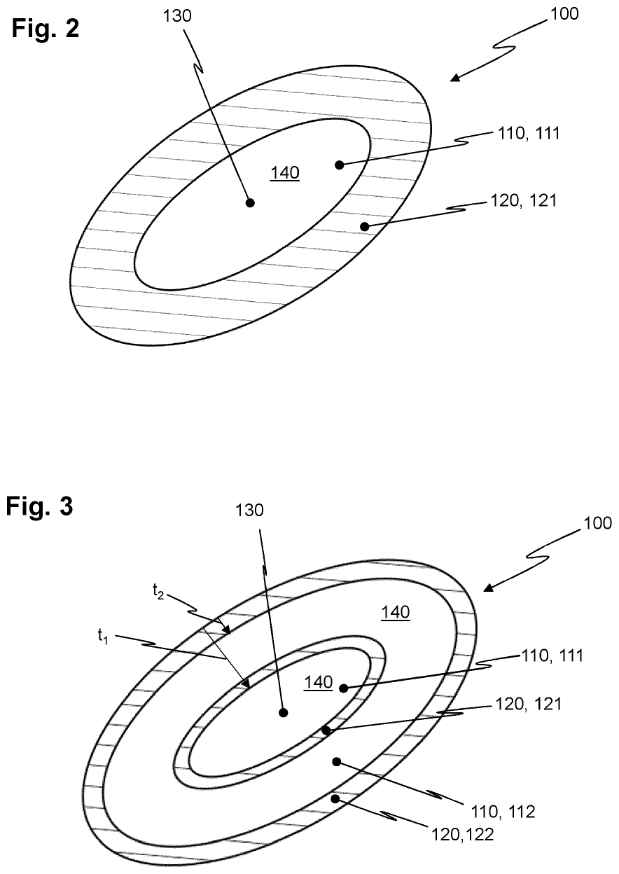

In FIGS. 2 and 3, exemplary embodiments of a seed capsule 100 according to the invention are shown schematically in a sectional view. The seed capsule 100 has an essentially ellipsoidal shape with a center point 130. In the area of the center point 130, a first or innermost receiving volume 110, 111 is provided, in which one or more active and/or stimulation substances 140 to be released are contained. Active and/or stimulating substances 140 are preferably biostimulators, in particular effective microorganisms, fungi, mycorrhizal fungi or bacteria, but also other biological plant additives such as humus or amino acids, etc., which are included in liquid or viscous or preferably solid form in the intake volume 110, 111. The receiving volume 110, 111 is surrounded, preferably completely, by a first or innermost encasing layer 120, 121. The first encasing layer 120, 121 is soluble and/or decomposable, in particular water-soluble, and dissolves, for example, through contact with surrounding soil 300 or the moisture contained therein after a predefinable time interval t₁, t₂. The predeterminable time interval t₁, t₂ can be set, for example, by the layer thickness and/or the solubility of the first encasing layer 120, 121.

As can be seen from FIG. 2, in an alternative embodiment, the seed capsule 100 contains a second receiving volume 110, 112, which surrounds the first encasing layer 120, 121, preferably completely, and contains one or more active and/or stimulation substances 140 to be released. The active and/or stimulation substances 140 contained in the respective receiving volume 110, 111, 112 and to be released can optionally be the same stimulation substance 140 or an identical mixture of active and/or stimulation substances 140 or different active and/or stimulation substances 140 or different mixtures of active and/or stimulation substances 140. For example, a stimulating substance 140, such as microorganisms, can be contained in the first receiving volume 110, 111 and either the same stimulating substance 140 (microorganisms and/or biostimulators) or a different stimulating substance 140, such as mycorrhizal fungi, can be contained in the second receiving volume 110, 112. It is also conceivable that the first receiving volume 110, 111 contains a mixture of active and/or stimulating substances 140, such as different microorganisms and/or biostimulators, and the second receiving volume 110, 111 either contains the same mixture of active and/or stimulating substances 140 or a different mixture of active and/or stimulating substances 140, such as different, preferably symbiotic types of fungus.

The second receiving volume 110, 112 is in turn surrounded, preferably completely, by a second or outermost encasing layer 120, 122. On the basis of the respective layer thicknesses of the encasing layers 120, 121, 122 and/or the receiving volumes 110, 112 lying between them, desired time intervals t₁, t₂ until the corresponding active and/or stimulation substances 140 are released, can be set. In particular, via the layer thickness and/or the solubility of the second, outermost encasing layer 120, 122, a second time interval t₂ up to the release of the active and/or stimulation substances 140 contained in the second receiving volume 110, 112 can be specified. Correspondingly, via the layer thickness and/or the solubility of the second encasing layer 120, 122, the second receiving volume 110, 112 and the first encasing layer 120, 121, a first time interval t₁ until the active and/or stimulation substances 140 contained in the first receiving volume 110, 111 are released, can be specified.

The inventive concept also includes modifying sowing elements 200 known from the prior art for carrying out the method according to the invention.

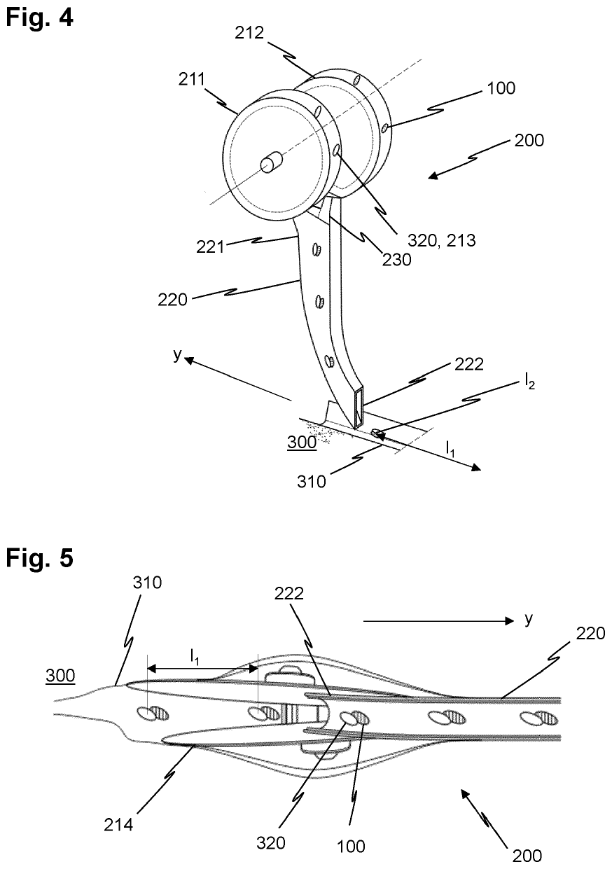

A schematic perspective illustration of a first exemplary modification of a sowing element 200 known from the prior art for carrying out the method according to the invention can therefore be seen from FIG. 4. The sowing element 200 comprises a first metering device 211, here designed as a chambered sowing disc, and a single-grain laying device 220, here designed as a sowing tube. Seeds are supplied to the first metering device 211 via a seed reservoir (not shown here), whereby a single grain 320 being received by a chamber 213 of the first metering device 211. Via the first metering device, 211 rotating here, the individual grains 320 received in the respective chambers 213 are successively fed to a first or upper end 221 of the individual grain-laying device 220 at regular time intervals. The second or lower end 222 of the single grain-laying device 220 opens into a seed furrow 310, which is drawn into the soil 300. As the sowing element 200 is pulled by an agricultural tractor along a pulling direction y, the individual grains 320 can be deposited at a first distance l₁ from one another within and along the seed furrow 310 via the second end 222 of the individual grain laying device 220. The first distance l₁ can be set by means of the pulling speed of the agricultural tractor and/or the rotational speed of the first metering device 211.

In terms of the invention and for carrying out the method according to the invention, the device known from the prior art is modified by providing a second metering device 212, which is also designed here as a rotating sowing disc. The second metering device 212 is preferably equipped with seed capsules 100 in a corresponding manner from a seed capsule reservoir (not shown here). The second metering device 212 is also connected to the upper end 221 of the single grain-laying device 220 via a connecting piece 230. According to a preferred variant of the method, the first metering device 211 and the second metering device 212 are switched synchronously with each other. Thus, exactly one seed capsule 100 and exactly one single grain 320 are fed to the first end 221 of the single grain laying device 220 at the same time and can be deposited within the seed furrow 310 adjacent and touching one another via the second end 222. Alternatively, the first metering device 211 and the second metering device 212 can be switched synchronously to one another with an offset with respect to the direction of rotation. This way the single grain 320 and the seed capsule 100 are fed to the first end 221 of the single grain laying device 220 via the connecting piece 230 with a corresponding time offset. In this way, a desired, second distance l₂ (not shown here) between the single grain 320 and the seed capsule 100 can be set. Instead of a second metering device 212, it is also conceivable to make the first metering device 211 axially wider and to subdivide its chambers 213 axially into a first area for receiving the single grain 320 and a second area for receiving the seed capsule 100. In this way, single grain 320 and seed capsule 100 can be fed with the same metering device 210 along two adjacent channels of the connecting piece 230 of the single grain-laying device 200, whereby a synchronous deposit is ensured and a synchronous switching of several metering devices 210 is not necessary. It is also conceivable to arrange respective chambers 213 of a metering device 210 for receiving a single grain 320 or a seed capsule 100 at different radii of the metering device 210 designed as a seeding disc. In this way, the single grain 320 and the one or more assigned seed capsules 100 can be fed to channel openings of the connecting piece 230 which are arranged synchronously above or below one another.

A setting of the number x (here: x=1) of seed capsules 100, which are assigned to the respective individual grain 320, can be made, for example, by different rotation speeds and/or diameters that differ from one another and/or the respective number of chambers 213 of the first metering device 211 and the second metering device 212 and/or by filling the chambers 213 with seed capsules 100 (for example two or more seed capsules 100 per chamber 213, corresponds to x=2 or more, or only the filling of every second chamber 213 with a seed capsule 100 corresponds to x=0.5).

A similar sowing element 200, also known from the prior art, for carrying out the method according to the invention is shown in FIG. 5 in a schematic plan view and its essential structure corresponds to the previously described first exemplary embodiment according to FIG. 4. The sowing element 200 comprises a single grain-laying device 220, the second end 222 of which opens between two disks 214 rolling on the ground 300 and provided for forming the seed furrow 310. Both individual grains 320 and seed capsules 100 can be deposited or placed within and along the seed furrow 310 with a desired, set, first distance l₁ via the single grain laying device 220. The setting of the process variables or parameters l₂, x takes place as described above.

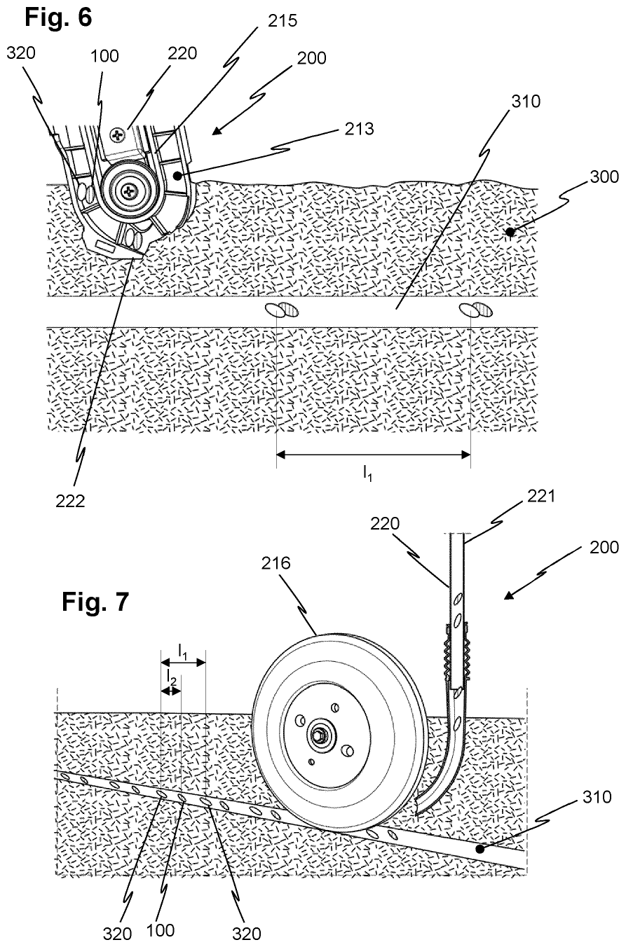

A third exemplary modification of a sowing element 200 known from the prior art can be seen in FIG. 6 and its essential structure corresponds to the above-described embodiments. The single grain-laying device 220 is provided here with a circumferential belt 215, which rotates chambers 213 for receiving the single grain 320 between the first end 221 and the second end 222 of the single grain laying device 220. At the first end 221, the chambers 213 can be equipped with individual grains 320 by a first metering device 211 (not shown here). The revolving belt 215 moves the equipped chambers 213 to the second end 222 of the single grain laying device 220, which in turn opens into the seed furrow 310 for placing the single grains 320. To carry out the method according to the invention, a chamber 213 containing a single grain 320 can additionally be equipped with one or more seed capsules 100, for example by means of a second metering device 212, also not shown here. In order to place the single grain 320 and the assigned seed capsules 100 at a second distance l₂ (not shown here) from one another within the seed furrow 310, it is of course also conceivable to feed the chambers 213 alternately with a single grain 320 and one or more seed capsules 100.

According to a fourth exemplary embodiment, as shown schematically and in perspective in FIG. 7, the single grain laying device 220 shown here is designed flexible and hose-like as a sowing element 200 known from the prior art and it moves in front of a closing wheel 216. In order to apply a single grain 320 and one or more assigned seed capsules 100 offset in time, or to place them at a distance l₂ from one another, a single grain 320 and an assigned seed capsule 100 can be fed to the first end 221 of the single grain laying device 220 one after the other. Alternatively, the single grain 320 and the assigned seed capsule 100 can be fed in at the same time, the distance l₂ between the two being guaranteed by the different mass and the corresponding falling speed caused by the gravitational force. In the illustration according to FIG. 7, a second distance l₂ between the single grain 320 deposited in the seed furrow 310 and an associated seed capsule 100 is also shown, which can be set by the time-shifted loading of the single grain laying device 220. The distance l₂ should preferably not exceed a length of 5 cm and particularly preferably be in a range between 1 cm and 3 cm.

### LIST OF REFERENCE SYMBOLS

100 seed capsule
110 receiving volume
111 first receiving volume
112 second receiving volume
120 encasing layer
121 first encasing layer
122 second encasing layer
130 center point of the seed capsule
140 stimulation substance
200 sowing element
210 metering device
211 first metering device
212 second metering device
213 chamber
214 rolling disc
215 circumferential belt
216 closing wheel
220 single grain-laying device
221 first end of the single grain-laying device
222 second end of the single grain-laying device
300 soil
310 seed furrow
320 single grain
l₁ first distance
l₂ second distance
t₁ first time interval
t₂ second time interval
x number
y pull direction
z₁ first release period and/or release time
z₂ second release period and/or release time

1. A method for single-grain application of seed by means of an agricultural sowing unit with at least one sowing element (200), the sowing element (200) having a metering device (210, 211, 212) for the single-grain placement of the seed along or within a seed furrow (310) arranged in the soil (300) and a single grain laying device (220), wherein
in each case a single grain (320) of the seed is deposited along or within the seed furrow (310), adjacent to other individual seed grains (320) at a first distance (l₁) that can be selected or adjusted as required,
characterized in that
to each single grain (320) of the seed is assigned a number (x) of seed capsules (100) that can be selected or specified as required,
the seed capsules (100) are placed adjacent to the assigned single grain (320) along or within the seed furrow (310), and
active or stimulating substances (140) contained in the seed capsules (100) are released to support or stimulate the associated single grain (320).

2. The method according to claim 1,
characterized in that
the seed capsule (100) has at least one receiving volume (110, 111, 112) and at least one soluble or decomposable layer (120, 121, 122) encasing the receiving volume (110, 111, 122) the encasing layer (120, 121, 122) is being dissolved and/or decomposed for the release of the active or stimulating substances (140) contained therein.

3. The method according to claim 2,
characterized in that
the at least one encasing layer (120, 121, 122) of the seed capsule (100) is water-soluble and is dissolved through contact with the surrounding soil (300) for releasing the active or stimulating substances (140) contained in the at least one receiving volume (110, 111, 112).

4. The method according to claim 1,
characterized in that
between the placement of the seed capsules (100) along or within the seed furrow (310) and the release of the active or stimulation substances (140) contained in the seed capsules (100), an optionally selectable time interval (t₁, t₂) for establishing a release period or time (z₁, z₂) is specified.

5. The method according to claim 4,
characterized in that
the time interval (t₁, t₂) between the placement of the seed capsules (100) and the release of the active or stimulating substances (140) is specified via the solubility or the layer thickness of the encasing layer (120, 121, 122).

6. The method according to claim 5,
characterized in that
the seed capsule (100) has at least two receiving volumes (110, 111, 112) and at least two soluble or decomposable layers (120, 121, 122) encasing a respective receiving volume (110, 111, 112), wherein the encasing layers (120, 121, 122) for releasing of the contained active or stimulating substances (140), are dissolved or decomposed through contact with the surrounding soil (300).

7. The method according to claim 1,
characterized in that
the seed capsules (100) are placed essentially simultaneously with the assigned single grain (320) by means of the sowing element (200) along or within the seed furrow (310), whereby the seed capsules (100) and the assigned single grain (320) are arranged in the immediate vicinity to each other.

8. The method according to claim 1,
characterized in that
the seed capsules (100) are placed or deposited with a time offset in relation to the assigned single grain (320) by means of the sowing element (200) along or within the seed furrow (310), whereby the seed capsules (100) and the assigned single grain (320) are arranged in the immediate vicinity and at a second distance (l₂) from one another, which second distance (l₂) is specified on the basis of the time offset.

9. The method according to claim 1,
characterized in that
the sowing element (200) has at least one first metering device (211) for placing the seed capsules (100) and at least one second metering device (212) for depositing the assigned single grain (320), and wherein the seed capsules (100) and the assigned single grain (320) are placed or deposited via a common single-grain laying device (220) along or within the seed furrow (310).

10. The method according to claim 1,
characterized in that
the sowing element (200) has a common metering device (210, 211, 212) for placing the seed capsules (100) and for depositing the associated single grain (320), by means of which both the seed capsules (100) and the seeds are separated, and wherein the seed capsules (100) and the associated single grain (320) are placed over the single grain laying device (220) along or within the seed furrow (310).

11. Seed A seed capsule (100), suitable for single grain placement by means of an agricultural sowing unit with at least one sowing element (200),
characterized in that
the seed capsule (100) consists of at least of one receiving volume (110, 111, 112) containing active or stimulating substances (140) and of at least one soluble or decomposable encasing layer (120, 121, 122) enveloping the receiving volume (110, 111, 112), whereby the encasing layer (120, 121, 122) is dissolvable or decomposable for releasing of the active or stimulating substances (140) contained therein.

12. Seed A seed capsule (100) according to claim 11,
characterized in that
the seed capsule (100) consists of at least two active or stimulating substances (140) containing receiving volumes (110, 111, 112) and of least two soluble or decomposable layers (120, 121, 122) encasing a respective receiving volume (110, 111, 112), whereby the encasing layers (120, 121, 122) and the respective receiving volumes (110, 111, 112) for releasing of the contained active or stimulating substances (140) at release periods or release times (z₁, z₂) that differ from one another, are arranged encasing one another starting from the center point of the seed capsule (100).

13. Seed A seed capsule (100) according to claim 12,
characterized in that
the active or stimulatory substances (140) contained in the at least one receiving volume (110, 111, 112) have at least one bio-stimulator.

14. A seed capsule (100) according to claim 11,
characterized in that
the at least one encasing layer (120, 121, 122) is soluble or decomposable, and is a carbonaceous material or a gel structure or a starchy material or biodegradable plastics.

15. A seed capsule according to claim 13 wherein the at least one bio-stimulator is a bio-stimulator selected from the group consisting of effective microorganisms, amino acids, humic acids, fulvic acids, algae, seaweed extracts, beneficial fungi, mycorrhizal fungi, beneficial bacteria, chitin, inorganic components and molasses
